(19) United States
(12) Patent Application Publication
(10) Pub. No.: US 2025/0071326 A1
(43) Pub. Date: Feb. 27, 2025

(54) INTEGRATING A DECODER FOR HIERARCHICAL VIDEO CODING

(71) Applicant: V-NOVA INTERNATIONAL LIMITED, London (GB)

(72) Inventors: Rahul DEY, London (GB); Colin Middleton, London (GB)

(21) Appl. No.: 18/728,379

(22) PCT Filed: Jan. 9, 2023
(86) PCT No.: PCT/GB2023/050029

§ 371 Date: Jul. 11, 2024

(30) Foreign Application Priority Data
Jan. 11, 2022 (GB) 2200285.1
Sep. 14, 2022 (GB) 2213485.2

(51) Int. Cl. H04N 19/597; G06T 1/20; G06T 15/04; G06T 15/80; H04N 19/30; H04N 19/44

(52) U.S. Cl. CPC H04N 19/597; G06T 1/20; G06T 15/04; G06T 15/80; H04N 19/30; H04N 19/44

(57) ABSTRACT

According to examples there may be provided a method of implementing an enhancement decoding, comprising: obtaining a preliminary set of residuals from an encoded enhancement signal comprising one or more layers of residual data, the one or more layers of residual data being generated based on a comparison of data derived from a decoded video signal and data derived from an original input video signal; and, instructing a drawing or addressing of the preliminary set of residuals on a texture of a GPU to combine the preliminary set of residuals with a set of temporal residual values, wherein the texture acts as a temporal buffer storing the set of temporal residual values. A system, video decoder, decoder integration layer and computer readable medium are also provided.

### BACKGROUND

A hybrid backward-compatible coding technology has been previously proposed, for example in WO 2014/170819 and WO 2018/046940, the contents of which are incorporated herein by reference. Further examples of tier-based coding formats include ISO/IEC MPEG-5 Part 2 LCEVC (hereafter “LCEVC”). LCEVC has been described in WO 2020/188273A1, and the associated standard specification documents including the Draft Text of ISO/IEC DIS 23094-2 Low Complexity Enhancement Video Coding published at MPEG 129 meeting in Brussels, held Monday, 13 Jan. 2020 to Friday, 17 Jan. 2020, both documents being incorporated by reference herein in their entirety.

In these coding formats a signal is decomposed in multiple “echelons” (also known as “hierarchical tiers”) of data, each corresponding to a “Level of Quality”, from the highest echelon at the sampling rate of the original signal to the lowest echelon. The lowest echelon is typically a low quality rendition of the original signal and other echelons contain information on correction to apply to a reconstructed rendition in order to produce the final output.

LCEVC adopts this multi-layer approach where any base codec (for example Advanced Video Coding—AVC, also known as H.264, or High Efficiency Video Coding—HEVC, also known as H.265) can be enhanced via an additional low bitrate stream. LCEVC is defined by two component streams, a base stream typically decodable by a hardware decoder and an enhancement stream consisting of one or more enhancement layers suitable for software processing implementation with sustainable power consumption. The enhancement provides improved compression efficiency to existing codecs, and reduces encoding and decoding complexity.

Since LCEVC and similar coding formats leverage existing decoders and are inherently backwards-compatible, there exists a need for efficient and effective integration with existing video coding implementations without complete re-design. Examples of known video coding implementations include the software tool FFmpeg, which is used by the simple media player FFplay.

LCEVC is not limited to known codecs and is theoretically capable of leveraging yet-to-be-developed codecs. As such any LCEVC implementation should be capable of integration with any hitherto known or yet-to-be-developed codec, implemented in hardware or software, without introducing coding complexity.

The approach of LCEVC being a codec agnostic enhancer based on a software-driven implementation, which leverages available hardware acceleration, shows in the wide variety of implementation options available on the decoding side. While existing decoders are typically implemented in hardware at the bottom of the stack, LCEVC allows for implementation on a variety of levels i.e., from Scripting and Application to the OS and Driver level and all the way to the SoC and ASIC. Generally speaking, the lower in the stack the implementation takes place, the more device-specific the approach becomes. In almost all implementations, no new hardware is needed.

Each of these myriad implementation options brings unique challenges, partly owing to the nature of the LCEVC residuals data. At a high-level, LCEVC reconstruction involves a frame of LCEVC residuals data being combined with a decoded frame of the base data to reconstruct the original frame. Generally speaking this LCVEC residual data is sparse data. That is, a frame of LCEVC residual data generally comprises many zeros and few values, often in the form of lines, leading to implementation optimisation opportunities.

In one example of the software-driven implementation options, a decoder may be implemented using a GPU, either of a specific video decoder chipset or of a general purpose computer. Typically GPUs can be instructed using application programming interfaces (APIs) to render computer graphics and outsource real-time rendering calculations. Such APIs can be cross-language or cross-platform, e.g. OpenGL, or unique to the operation system, e.g. Metal. To instruct a GPU, a CPU will typically load data, e.g. a set of pixel values, into memory accessible by the GPU and instruct the GPU to perform an operation on that data.

For example in the case of texture mapping, an image is loaded to the GPU and the pixels of that image are mapped to the surface of a shape or polygon.

While utilising the GPU to perform aspects of the decoding and rendering stages of LCEVC reconstruction has the potential to provide performance optimisations, loading pixel data into memory accessible by the GPU so that it may perform operations on that data is inefficient and resource intensive. Optimisations are sought which improve the integration and implementation of LCEVC into software-driven approaches so as to improve and facilitate wide-scale adoption of the technology.

### SUMMARY

Aspects and variations of the present invention are set out in the appended claims. Certain unclaimed aspects are further set out in the detailed description below.

According to one aspect there is provided a method of implementing an enhancement decoding, comprising: obtaining a preliminary set of residuals from an encoded enhancement signal comprising one or more layers of residual data, the one or more layers of residual data being generated based on a comparison of data derived from a decoded video signal and data derived from an original input video signal; and, instructing combining of the preliminary set of residuals with a texture of a GPU to combine the preliminary set of residuals with a set of temporal residual values, wherein the texture acts as a temporal buffer storing the set of temporal residual values.

Drawing the residuals on a texture acting as a temporal buffer in this way improves the resource usage and computational efficiency of an LCEVC reconstruction. That is, the amount of data required to be loaded to the GPU is reduced. When implementing an LCEVC reconstruction the uploading of pixel values to a texture can be inefficient and create a bottleneck in computational processing. However, by drawing the preliminary set of residuals onto a texture, rather than loading the full set of residuals to the GPU, the frequency and volume of data required to the loaded to the GPU can be reduced.

In the context of the present disclosure, combining may refer to the process of drawing to or directly addressing a texture.

Preferably the method further comprises instructing a GPU shader to apply the texture to a decoded frame of video to generate a decoded reconstruction of the original input signal. Thus, the functionality of the GPU, which excels in additions and computationally efficient rendering, can be utilised to generate a Surface of the original input video using the data stored in the texture, that is, the updated or modified temporal buffer.

The step of instructing combining may comprise instructing the GPU using an API of the GPU and storing the preliminary set of residuals in memory accessible by the GPU.

In some examples the instructing combining comprises packing values of the preliminary set of residuals as channel values of the texture. By this we mean as channel values of a pixel of a texture.

In certain implementations, each value of a 2 by 2 block of a frame of the preliminary set of residuals may be packed into respective channels of the texture. That is, respective channels of a pixel of the texture.

Optionally, each 4 by 1 row or column of a 4 by 4 block of a frame of the preliminary set of residuals may be packed into the channels of a pixel of the texture.

It is also contemplated that each 1 by 4 column of a 4 by 4 block of a frame of the preliminary set of residuals may be packed into the channels of a pixel of the texture. However, even when processing a 4 by 4 block of a frame, it may still be advantageous to pack 2 by 2 blocks of the 4 by 4 block in respective channels of a pixel of the texture, so that all blocks are processed in the same way. This reduces processing complexity.

Further, instructing combining may comprise instructing addressing elements of the texture to modify the texture data. In some examples, the instructing combining may comprise instructing directly addressing elements of the texture to modify the texture data. In advantageous implementations the instructing comprises invoking a compute shader to directly address the elements of the texture.

In further examples, each element of the texture is directly addressed by the compute shader.

Directly addressing the residuals with a compute shader may, depending on the circumstances, provide efficiency benefits when compared to an invocation of another shader type, such as a fragment shader. This is because a compute shader can be invoked on individual pixels, rather than causing invocations for adjacent pixels which are not to be updated. Therefore, no shader invocations are wasted. For example, where a transform unit corresponds to a pixel on a texture, certain shaders may cause invocations of a block of the area, even if not all pixels (i.e. transform units) are to be updated. Using a compute shader instead of a fragment shader effectively allows for more fine-grained control over the number of shader invocations.

Advantageously, instructing combining may comprise instructing a drawing of the preliminary set of residuals on the texture of the GPU. In this context this may take the form of creating lines, points or shapes on a texture so as to recreate the values intended to be stored in the buffer.

In certain embodiments the step of drawing may further comprise encoding the preliminary set of residuals as geometry data. Coding the residuals as geometry data in this way may further reduce the amount of data being required to be loaded to the GPU. A set of preliminary residuals to be applied to the temporal buffer may be broken into smaller units for drawing effectively.

Leveraging the sparse data and lines of a typical frame of residual data, aspects of the present disclosure propose that differences between the current frame and the LCEVC temporal buffer can be drawn on a texture using the GPU, rather than the differences being combined with a temporal buffer stored in CPU memory during decoding before the pixels are loaded to the GPU.

The method may be performed by a client or application.

In implementations, components or surfaces, such as Luma Y, Chroma U and Chroma V, may be decoded separately by an OpenGL Pipeline Core before being merged to produce an output.

Advantageously the implementation using a GPU and GPU textures allows the processes to be performed in a Secure pipeline, for example on secure memory. In examples, GPU API resources may be protected or unprotected. GPU Shader Shader protection status may be based on the protection status of the output target.

The use of GPU API extensions may also ensure that video held in a protected resource is never exposed to unprotected resources (such as the CPU). They are used by DRM implementations to provide isolation of video content from the CPU. The DRM decrypts video into protected resources, which cannot then be moved to unprotected resources as it is decoded and rendered. The implementation proposed may not modify the base layer pipeline in any way and so cannot compromise the security of the base layer.

Additionally, the step of encoding the preliminary set of residuals as geometry data may further comprise packing values of the preliminary set of residuals as channel values of the texture. Accordingly the GPU memory usage is minimised by packing the data into each individual channel for subsequent extraction by the GPU. Provided the GPU knows where the residual values are stored, they can easily be retrieved by the GPU for use, utilising the concept that the set of residuals are 2-dimensional blocks of data. Channel values may for example be Red, Green, Blue or Alpha.

In one implementation each value of a 2 by 2 block of a frame of the preliminary set of residuals is packed into a respective channel of the texture. That is, respective channels of a pixel of the texture. In a further implementation each 4 by 1 row of a 4 by 4 block of a frame of the preliminary set of residuals is packed into a set of channels of the texture. In examples, this may be a single pixel location. For example, the RGBA values of a pixel location. Thus different coding units can be efficiently stored.

The preliminary set of residuals may be encoded as at least one vertex and at least one attribute. For example, a vertex having two associated attributes. Preferably the at least one attribute may comprise an attribute corresponding to a location of residuals in a frame and at least one attribute corresponding to a value of a residual in the preliminary set of residuals.

In certain embodiments a 2 by 2 block of a frame of the preliminary set of residuals may be encoded as one vertex and two attributes, wherein a first attribute comprises a location of the block in the frame and a second attribute comprises values of each residual in the block. The location may be a coordinate location to locate the block. Thus the values of the frame can be efficient loaded to the GPU.

The second attribute may comprise a four channel values, each channel value including a respective residual value in the block.

A 4 by 4 block of a frame of the preliminary set of residuals may be encoded as one vertex and five attributes, wherein a first attribute comprises a location of the block in the frame and four attributes comprise values of each residual in the block. Thus only five values are needed to load a block of values onto the GPU for drawing to a texture and locating the drawing.

In preferred embodiments the method may comprise obtaining an instruction to set or apply a plurality of residual values in the preliminary set of residuals to a region of the temporal buffer; and, drawing the plurality of residual values on the texture as a plurality of points. In doing so the texture acting as the temporal buffer can be efficiently updated using blocks of the frames of residual data and thus further improving efficiency.

The method may further comprise: obtaining an instruction to clear a region of the temporal buffer; encoding the instruction as at least one triangle; and, drawing the at least one triangle on the texture to clear a region of the texture. In this way, regions of the texture acting as the temporal buffer can be efficiently cleared without sending large volumes of data to the GPU. In this implementation, the method may comprise encoding the instruction as six vertices and one attribute. For example each of the vertices having one associated attribute.

In certain implementations the method may comprise obtaining a plurality of instructions to perform operations on the temporal buffer for a frame of the preliminary set of residuals, each of the plurality of instructions having an associated operation type; grouping the plurality of instructions together according to their associated operation type; and, sending each group of instructions to the GPU as a single drawing operation. This single drawing operation for each type can thus reduce the instructions and memory resources and bandwidth used to instruct the GPU to update the texture acting as the temporal buffer.

The method may be performed at a decoder integration layer which controls operation of one or more decoder plug-ins and an enhancement decoder to generate a decoded reconstruction of the original input video signal using a decoded video signal from a base encoding layer and one or more layers of residual data from the enhancement encoding layer, wherein the one or more decoder plug-ins provide a wrapper for one or more respective base decoders to implement a base decoding layer to decode an encoded video signal, each wrapper implementing an interface for data exchange with a corresponding base decoder and wherein the enhancement decoder implements the enhancement decoding layer, the enhancement decoder being configured to: receive an encoded enhancement signal; and, decode the encoded enhancement signal to obtain the one or more layers of residual data.

Thus a decoder plug-in may instead of providing residuals as an image plane, provide a list of the operations it needs to change the last frame's residual image to the current frame's residual image. The function may instruct the modification of the temporal buffer to include the changes in the current frame.

With aspects of the present disclosure, responsibility is passed to the decoder integration layer. The decoder plug-ins provide the instructions but do not perform or instruct the drawing.

The method may further comprise receiving one or more instructions from the one or more decoder plug ins, the instructions instructing an update of the temporal buffer; and, converting the one or more instructions into one or more draw commands to be sent to the GPU to update the texture.

Preferably the enhancement decoder is an LCEVC decoder such that the decoder integration layer, one or more plug-ins and the enhancement decoder together provide an LCEVC decoding software solution. The LECVC decoding software stack may be implemented in one or more LCEVC decoder libraries and thus provides an optimised software library for decoding MPEG-5 enhanced streams.

LCEVC decoding is extremely lightweight, often freeing up resources and matching or reducing battery power consumption vs. native base codec decoding. The approaches provides for rapid deployment of LCEVC across all platforms, including support of different base encodings and decoder implementations.

The decoder integration layer may also include control operation of an upscale operation to upscale the decoded video signal from the base encoding layer so that the one or more layers of residual data may be applied to the decoded video signal from the base encoding layer.

The decoder can be easily implemented on popular media players across platforms such as iOS (RTM), Android (RTM) and Windows (RTM).

The one or more decoder plug-ins may be configured to instruct the corresponding base decoder through a library function call or operating system function call. Function calls may include for example, Android (RTM) mediacodec, VTDecompressionSession and MFT depending on the operating system. Hence, different base decoding implementations may be easily supported, including native implementations within an operating system and hardware-accelerated decoding.

The decoder integration layer may be configured to apply the one or more layers of residual data from the enhancement encoding layer to the decoded video signal from the base encoding layer to generate the decoded reconstruction of the original input video signal. In certain cases, the decoder integration layer may instruct a plug-in from the set of decoder plug-ins to apply the one or more layers of residual data; in other cases, the decoder integration layer may obtain a decoded output from the base encoding layer that was instructed using the decoder plugin and combine this with the output of the enhancement decoder. Preferably the layers of residual data may be applied during playback.

In certain embodiments the decoder integration layer is configured to receive: one or more input buffers comprising the encoded video signal and the encoded enhancement signal in an encoding order, wherein the one or more input buffers are also fed to the base decoders; and, one or more base decoded frames of the decoded video signal from the base encoding layer, in presentation order. In this way minimal processing is needed by a client and the integration takes care of the operation for the client. The same input buffers can be passed to the base decoding layer and the enhancement decoding layer to aid simplicity.

In particularly preferred embodiments, the control interface comprises an output type configuration parameter, wherein the decoder integration layer is configured to vary how the decoded reconstruction of the original input video signal is output based on a value of the output type configuration parameter. The value of the output type configuration parameter may be stored in a configuration data structure retrieved by the decoder integration layer upon initialisation.

In one example of a configured output, the decoder integration layer is configured to output the decoded reconstruction of the original input video signal as one or more buffers. In another example, the decoder integration layer is configured to output the decoded reconstruction of the original input video signal as one or more on-screen surfaces. Alternatively, the decoder integration layer is configured to output the decoded reconstruction of the original input video signal as one or more off-screen textures. Each of these three example outputs may be selected by the output type configuration parameter.

Where the output is selected to be one or more off-screen textures, the control interface may comprise a render instruction and, when the decoder integration layer receives the render instruction the decoder integration layer may be configured to render the off-screen texture. This is particularly useful when a client wants to finely manage the time of display of each frame and perhaps keep a queue of decoded frames ready for display at the right time. For this use, a separate render function is provided, that is, the render instruction.

The control interface may comprise a pipeline mode parameter, wherein the decoder integration layer is configured to control stages of the enhancement layer to be performed on a central processing unit (CPU) or graphical processing unit (GPU) based on a value of the pipeline mode parameter. For example, in one pipeline mode all the LCEVC stages may be performed in a CPU while a GPU is used only for a possible colour component (e.g. YUV/RGB) conversion. Similarly, in another mode, most of the LCEVC stages may be performed in a GPU using graphics library (GL) shaders, including colour component (e.g. YUV/RGB) conversions, while the CPU may be only used to produce the LCEVC residual planes. The configuration of the present decoder allows efficient distribution of processing across CPUs/GPUs, and for this to be configured via the decoder integration layer.

The decoder integration layer may be configured to fall back to passing an output of the base decoding layer as the decoded reconstruction of the original input video signal where no encoded enhancement signal is received. This is particularly beneficial as a video signal may still be output, albeit at a lower resolution than if an enhancement signal had been received successfully.

The control interface may comprise a skip frame instruction and the decoder integration layer may be configured to control the operation to not decode a frame of the encoded enhancement signal and/or not decode a frame of the encoded video signal in response to receiving the skip frame instruction. When a client skips frames, for example, because of a seek in the timeline, or drops frames because they are ‘late,’ it may alert the decoder integration layer using a suitable function. The decoder integration layer falls back to a ‘no operation’ case if the skip instruction is received. This alert may be used to internally perform a minimal frame decoding to keep reference decoding buffer consistent or may fall back to no operation.

The one or more decoder plug-ins may provide a base control interface to the base decoder layer to call functions of the corresponding base decoder. The plug-ins thus provide an application programming interface (API) to control operations and exchange information.

The control interface may comprise a set of predetermined encoding options, wherein the decoder integration layer is configured to retrieve a configuration data structure comprising a set of decoding settings corresponding to the set of predetermined decoding options. The configuration data structure may be retrieved by the decoder integration layer upon initialisation. Examples of decoding settings include: graphics library versions (e.g. OpenGL major and minor versions or the use of graphics library functions for embedded systems such as OpenGL ES); bit-depth, e.g. use of 8 or 16 bit LCEVC residual planes; use of hardware buffers; user interface (UI) configurations (e.g. enabling an on-screen UI for stats and live configuration); and logging (e.g. enabling dumping stats and/or raw output frames to local storage).

In certain embodiments, the decoder integration layer may be configured to receive, via the control interface, an indication of a mode in which the decoder integration layer should control operation of the one or more decoder plug-ins and the enhancement decoder, wherein, in a synchronous mode, the decoder integration layer may be configured to block a call to a decode function until decoding is complete; and, in an asynchronous mode, the decoder integration layer may be configured to return (e.g. immediately) upon call to a decode function and call back when decoding completes. Thus, the decoder integration layer can be used in either synchronous or asynchronous mode, optionally by implementing a decode function in either mode.

Using the decoder integration layer is simplified for client applications, since the control interface operates at a relatively high-level, has a small number of commands and hides additional complexity. The control interface may comprise a set of functions to instruct respective phases of operation of the decoder integration layer, the set of functions comprising one or more of: a create function, in response to which an instance of the decoder integration layer is created; a destruct function, in response to which the instance of the decoder integration layer is destroyed; a decode function, in response to which the decoder integration layer controls operation of the one or more decoder plug-ins and the enhancement decoder to generate a decoded reconstruction of the original input video signal using and the one or more layers of residual data from the enhancement encoding layer; a feed input function which passes an input buffer comprising the encoded video signal and the encoded enhancement signal to the video decoder; and, a call back function, in response to which the decoder integration layer will call back when the decoded reconstruction of the original input video signal is generated. The call back may be thought of as a registered for alert which indicates to a client that the decoding is complete.

According to a further aspect there may be provided a computer readable medium comprising instructions which when executed by a processor, cause the processor to perform the method according to any of the above aspects.

According to a further aspect there may be provided a video decoder, comprising: a decoder integration layer to generate a decoded reconstruction of the original input video signal using a decoded video signal from a base encoding layer and one or more layers of residual data from an enhancement encoding layer, wherein the decoder integration layer is configured to perform the method of any of the above aspects.

The video decoder may further comprise: one or more decoder plug-ins that provide a wrapper for one or more respective base decoders to implement a base decoding layer to decode an encoded video signal, each wrapper implementing an interface for data exchange with a corresponding base decoder; an enhancement decoder to implement an enhancement decoding layer, the enhancement decoder being configured to: receive an encoded enhancement signal; and, decode the encoded enhancement signal to obtain one or more layers of residual data, the one or more layers of residual data being generated based on a comparison of data derived from the decoded video signal and data derived from an original input video signal, and wherein the decoder integration layer provides a control interface for the video decoder.

According to a further aspect there may be provided a video decoding system, comprising: a video decoder according to the above aspects; and, one or more base decoders. Examples of the one or more base codecs include, for example, AVC, HEVC, VP9, EVC, AV1 and may be implemented in software or hardware as is commonplace in this field.

The video decoding system may further comprise a client which provides one or more calls to the video decoder via the control interface to instruct generation of a decoded reconstruction of an original input video signal using the video decoder.

### BRIEF DESCRIPTION OF FIGURES

Examples of systems and methods in accordance with the invention will now be described with reference to the accompanying drawings, in which:

FIG. 1 shows a known, high-level schematic of an LCEVC decoding process;

FIGS. 2a and 2b respectively show a schematic of a comparative base decoder and a schematic of a decoder integration layer in a video pipeline;

FIG. 3 shows a schematic of an LCEVC reconstruction process using a GPU to render a frame;

FIG. 4 shows a schematic of an LCEVC reconstruction process using a GPU to render a frame according to examples of the present disclosure;

FIGS. 5a and 5b respectively show LCEVC coding units and their respective values;

FIGS. 6a, 6b and 6c conceptually illustrate texture packing of coding units into channels;

FIG. 7 shows a flow chart of methods according to the present disclosure;

FIGS. 8a to 8b illustrate a flow chart of steps performed in response to instructions received at a decoder integration layer according to the present disclosure;

FIGS. 9A to 9C illustrate a pixel grid containing DD transform units and a number of shader invocations needed when a fragment shader is used compared to when a compute shader is used;

FIGS. 10A to 10C illustrate a pixel grid containing a DDS transform unit and a number of shader invocations needed when a fragment shader is used compared to when a compute shader is used, and;

FIG. 11A to 11D show an example of the DD transform units corresponding to a diagonal line and the number shader invocations needed when a fragment shader is used compared to when a compute shader is used.

### DETAILED DESCRIPTION

This disclosure describes an implementation for integration of a hybrid backward-compatible coding technology with existing decoders, optionally via a software update. In a non-limiting example, the disclosure relates to an implementation and integration of MPEG-5 Part 2 Low Complexity Enhancement Video Coding (LCEVC). LCEVC is a hybrid backward-compatible coding technology which is a flexible, adaptable, highly efficient and computationally inexpensive coding format combining a different video coding format, a base codec (i.e. an encoder-decoder pair such as AVC/H.264, HEVC/H.265, or any other present or future codec, as well as non-standard algorithms such as VP9, AV1 and others) with one or more enhancement levels of coded data.

Example hybrid backward-compatible coding technologies use a down-sampled source signal encoded using a base codec to form a base stream. An enhancement stream is formed using an encoded set of residuals which correct or enhance the base stream for example by increasing resolution or by increasing frame rate. There may be multiple levels of enhancement data in a hierarchical structure. In certain arrangements, the base stream may be decoded by a hardware decoder while the enhancement stream may be suitable for being processed using a software implementation. Thus, streams are considered to be a base stream and one or more enhancement streams, where there are typically two enhancement streams possible but often one enhancement stream used. It is worth noting that typically the base stream may be decodable by a hardware decoder while the enhancement stream(s) may be suitable for software processing implementation with suitable power consumption. Streams can also be considered as layers.

The video frame is encoded hierarchically as opposed to using block-based approaches as done in the MPEG family of algorithms. Hierarchically encoding a frame includes generating residuals for the full frame, and then a reduced or decimated frame and so on. In the examples described herein, residuals may be considered to be errors or differences at a particular level of quality or resolution.

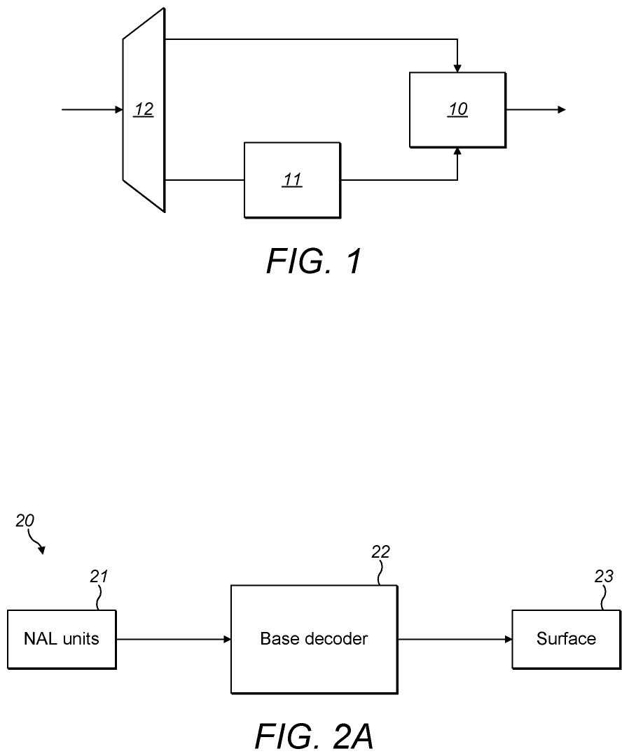

For context purposes only, as the detailed structure of LCEVC is known and set out in the approved draft standards specification, FIG. 1 illustrates, in a logical flow, how LCEVC operates on the decoding side assuming H.264 as the base codec. Those skilled in the art will understand how the examples described herein are also applicable to other multi-layer coding schemes (e.g., those that use a base layer and an enhancement layer) based on the general description of LCEVC that is presented with reference to FIG. 1. Turning to FIG. 1, the LCEVC decoder 10 works at individual video frame level. It takes as an input a decoded low-resolution picture from a base (H.264 or other) video decoder 11 and the LCEVC enhancement data to produce a decoded full-resolution picture ready for rendering on the display view. The LCEVC enhancement data is typically received either in Supplemental Enhancement Information (SEI) of the H.264 Network Abstraction Layer (NAL), or in an additional track or data Packet Identifier (PID) and is separated from the base encoded video by a demultiplexer 12. Hence, the base video decoder 11 receives a demultiplexed encoded base stream and the LCEVC decoder 10 receives a demultiplexed encoded enhancement stream, which is decoded by the LCEVC decoder 10 to generate a set of residuals for combination with the decoded low-resolution picture from the base video decoder 11.

By additional PID we mean additional track or PID. By this we mean not only Transport Stream (PID) but also ISO Base Media File Format and WebM as container types.

Throughout the present description, the invention may be described in the context of NAL units. However, it should be understood that the NAL units in this context may refer equally and more generally to elementary stream input buffers, or equivalent. That is, LCEVC is equally capable of supporting non-MPEG base codecs, i.e. VP8/VP9 and AV1, that typically do not use NAL encapsulation. So where a term NAL unit is used, the term may be read to mean an elementary stream input buffer, depending on the base codec utilised.

LCEVC can be rapidly implemented in existing decoders with a software update and is inherently backwards-compatible since devices that have not yet been updated to decode LCEVC are able to play the video using the underlying base codec, which further simplifies deployment.

In this context, there is proposed herein a decoder implementation to integrate decoding and rendering with existing systems and devices that perform base decoding. The integration is easy to deploy. It also enables the support of a broad range of encoding and player vendors and can be updated easily to support future systems.

The proposed decoder implementation may be provided through an optimised software library for decoding MPEG-5 LCEVC enhanced streams, providing a simple yet powerful control interface or API. This allows developers flexibility and the ability to deploy LCEVC at any level of a software stack, e.g. from low-level command-line tools to integrations with commonly used open-source encoders and players.

The terms LCEVC and enhancement may be used herein interchangeably, for example, the enhancement layer may comprise one or more enhancement streams, that is, the residuals data of the LCEVC enhancement data.

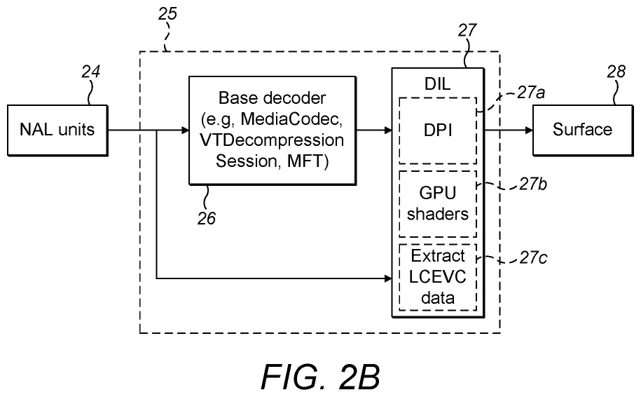

FIG. 2a illustrates an unmodified video pipeline 20. In this conceptual pipeline, obtained or received Network Abstraction Layer (NAL) units are input to a base decoder 22. The base decoder 22 may, for example, be a low-level media codec accessed using a mechanism such as MediaCodec (e.g. as found in the Android (RTM) operating system), VTDecompression Session (e.g. as found in the iOS (RTM) operating system) or Media Foundation Transforms (MFT—e.g. as found in the Windows (RTM) family of operating systems), depending on the operating system. The output of the pipeline is a surface 23 representing the decoded original video signal (e.g. a frame of such a video signal, where sequential display of success frames renders the video).

FIG. 2b illustrates a proposed video pipeline using an LCEVC decoder integration layer, conceptually. Like the comparative video decoder pipeline of FIG. 2a, NAL units 24 are obtained or received and are processed by an LCEVC decoder 25 to provide a surface 28 of reconstructed video data. Via the use of the LCEVC decoder 25, the surface 28 may be higher quality than the comparative surface 23 in FIG. 2a or the surface 28 may be at the same quality as the comparative surface 23 but require fewer processing and/or network resources.

As noted above, when we refer to NAL units here, we refer to elementary stream input buffers, or equivalent, depending on the base codec used.

In FIG. 2b, the LCEVC decoder 25 is implemented in conjunction with a base decoder 26. The base decoder 26 may be provided by a variety of mechanisms, including by an operating system function as discussed above (e.g. may use a MediaCodec, VTDecompression Session or MFT interface or command). The base decoder 26 may be hardware accelerated, e.g. using dedicated processing chips to implement operations for a particular codec. The base decoder 26 may be the same base decoder that is shown as 22 in FIG. 2a and that is used for other non-LCEVC video decoding, e.g. may comprise a pre-existing base decoder.

In FIG. 2b, the LCEVC decoder 25 is implemented using a decoder integration layer (DIL) 27. The decoder integration layer 27 acts to provide a control interface for the LCEVC decoder 25, such that a client application may use the LCEVC decoder 25 in a similar manner to the base decoder 22 shown in FIG. 2a, e.g. as a complete solution from buffer to output. The decoder integration layer 27 functions to control operation of a decoder plug-in (DPI) 27a and an enhancement decoder 27b to generate a decoded reconstruction of an original input video signal. In certain variations, as shown in FIG. 2b, the decoder integration layer may also control GPU functions 27c such as GPU shaders to reconstruct the original input video signal from the decoded base stream and the decoded enhancement stream.

NAL units 24 comprising the encoded video signal together with associated enhancement data may be provided in one or more input buffers. The input buffers may be fed by a similar non-MPEG elementary stream input buffer, such as used for example in VP8/VP9 or AV1. The input buffers may be fed (or made available) to the base decoder 26 and to the decoder integration layer 27, in particular the enhancement decoder that is controlled by the decoder integration layer 27. In certain examples, the encoded video signal may comprise an encoded base stream and be received separately from an encoded enhancement stream comprising the enhancement data; in other preferred examples, the encoded video signal comprising the encoded base stream may be received together with the encoded enhancement stream, e.g. as a single multiplexed encoded video stream. In the latter case, the same buffers may be fed (or made available) to both the base decoder 26 and to the decoder integration layer 27. In this case, the base decoder 26 may retrieve the encoded video signal comprising the encoded base stream and ignore any enhancement data in the NAL units. For example, the enhancement data may be carried in SEI messages for a base stream of video data, which may be ignored by the base decoder 26 if it is not adapted to process custom SEI message data. In this case, the base decoder 26 may operate as per the base decoder 22 in FIG. 2a, although in certain cases, the base video stream may be at a lower resolution that comparative cases.

On receipt of the encoded video signal comprising the encoded base stream, the base decoder 26 is configured to decode and output the encoded video signal as one or more base decoded frames. This output may then be received or accessed by the decoder integration layer 27 for enhancement. In one set of examples, the base decoded frames are passed as inputs to the decoder integration layer 27 in presentation order.

The decoder integration layer 27 extracts the LCEVC enhancement data from the input buffers and decodes the enhancement data. Decoding of the enhancement data is performed by the enhancement decoder 27b, which receives the enhancement data from the input buffers as an encoded enhancement signal and extracts residual data by applying an enhancement decoding pipeline to one or more streams of encoded residual data. For example, the enhancement decoder 27b may implement an LCEVC standard decoder as set out in the LCEVC specification.

A decoder plug-in is provided at the decoder integration layer to control the functions of the base decoder. In certain cases, the decoder plug-in 27a may handle receipt and/or access of the base decoded video frames and apply the LCEVC enhancement to these frames, preferably during playback. In other cases, the decoder plug-in may arrange for the output of the base decoder 26 to be accessible to the decoder integration layer 27, which is then arranged to control addition of a residual output from the enhancement decoder to generate the output surface 28. Once integrated in a decoding device, the LCEVC decoder 25 enables decoding and playback of video encoded with LCEVC enhancement.

Rendering of a decoded, reconstructed video signal may be supported by one or more GPU functions 27c such as GPU shaders that are controlled by the decoder integration layer 27, as exemplified in the examples given below and the aspects of the present disclosure.

In general, the decoder integration layer 27 controls operation of the one or more decoder plug-ins and the enhancement decoder to generate a decoded reconstruction of the original input video signal 28 using a decoded video signal from the base encoding layer (i.e. as implemented by the base decoder 26) and the one or more layers of residual data from the enhancement encoding layer (i.e. as implemented by the enhancement decoder). The decoder integration layer 27 provides a control interface, e.g. to applications within a client device, for the video decoder 25.

Depending on configuration, the decoder integration layer may output the surface 28 of decoded data in different ways. For example, as a buffer, as an off-screen texture or as an on-screen surface. Which output format to use may be set in configuration settings that are provided upon creation of an instance of the decoding integration layer 27. Implementation of these outputs are the subject of the present disclosure.

In certain implementations, where no enhancement data is found in the input buffers, e.g. where the NAL units 24 do not contain enhancement data, the decoder integration layer 27 may fall back to passing through the video signal at the lower resolution to the output, that is, the output of the base decoding layer as implemented by the base decoder 26. In this case, the LCEVC decoder 25 may operate as per the video decoder pipeline 20 in FIG. 2a.

The decoder integration layer 27 can be used for both application integration and operating system integration, e.g. for use by both client applications and operating systems. The decoder integration layer 27 may be used to control operating system functions, such as function calls to hardware accelerated base codecs, without the need for a client application to have knowledge of these functions. In certain cases, a plurality of decoder plug-ins may be provided, where each decoder plug-in provides a wrapper for a different base codec. It is also possible for a common base codec to have multiple decoder plug-ins. This may be the case where there are different implementations of a base codec, such as a GPU accelerated version, a native hardware accelerated version and an open-source software version.

When viewing the schematic diagram of FIG. 2b, the decoder plug-ins may be considered integrated with the base decoder 26 or alternatively a wrapper around that base decoder 26. Effectively FIG. 2b can be thought of as a stacked visualisation. The decoder integration layer 27 in FIG. 2b, conceptually includes functionality to extract the enhancement data from the NAL units 27b, functionality 27a to communicate with the decoder plug-ins and apply enhancement decoded data to base decoded data and one or more GPU functions 27c.

The set of decoder plug-ins are configured to present a common interface (i.e. a common set of commands) to the decoder integration layer 27, such that the decoder integration layer 27 may operate without knowledge of the specific commands or functionality of each base decoder. The plug-ins thus allow for base codec specific commands, such as MediaCodec, VTDecompression Session or MFT, to be mapped to a set of plug-in commands that are accessible by the decoder integration layer 27 (e.g. multiple different decoding function calls may be mapped to a single common plug-in “Decode ( . . . )” function).

Since the decoder integration layer 27 effectively comprises a ‘residuals engine’, i.e. a library that from the LCEVC encoded NAL units produces a set of correction planes at different levels of quality, the layer can behave as a complete decoder (i.e. the same as decoder 22) through control of the base decoder.

For simplicity, we will refer to the instructing entity here as the client but it will be understood that the client may be considered to be any application layer or functional layer and that the decoder integration layer 27 may be integrated simply and easily into a software solution. The terms client, application layer and user may be used herein interchangeably.

In an application integration, the decoder integration layer 27 may be configured to render directly to an on-screen surface, provided by a client, of arbitrary size (generally different from the content resolution). For example, even though a base decoded video may be Standard Definition (SD), the decoder integration layer 27, using the enhancement data, may render surfaces at High Definition (HD), Ultra High Definition (UHD) or a custom resolution. Further details of out-of-standard methods of upscaling and post-processing that may be applied to a LCEVC decoded video stream are found in PCT/GB2020/052420, the contents of which are incorporated herein by reference. Example application integrations include, for example, use of the LCEVC decoder 25 by ExoPlayer, an application level media player for Android, or VLCKit, an objective C wrapper for the libVLC media framework. In these cases, VLCKit and/or ExoPlayer may be configured to decode LCEVC video streams by using the LCEVC decoder 25 “under the hood”, where computer program code for VLCKit and/or ExoPlayer functions is configured to use and call commands provided by the decoder integration layer 27, i.e. the control interface of the LCEVC decoder 25. A VLCKit integration may be used to provide LCEVC rendering on iOS devices and an ExoPlayer integration may be used to provide LCEVC rendering on Android devices.

In an operating system integration, the decoder integration layer 27 may be configured to decode to a buffer or draw on an off-screen texture of the same size of the content final resolution. In this case, the decoder integration layer 27 may be configured such that it does not handle the final render to a display, such as a display device. In these cases, the final rendering may be handled by the operating system, and as such the operating system may use the control interface provided by the decoder integration layer 27 to provide LCEVC decoding as part of an operating system call. In these cases, the operating system may implement additional operations around the LCEVC decoding, such as YUV to RGB conversion, and/or resizing to the destination surface prior to the final rendering on a display device. Examples of operating system integration include integration with (or behind) MFT decoder for Microsoft Windows (RTM) operating systems or with (or behind) Open Media Acceleration (OpenMAX—OMX) decoder, OMX being a C-language based set of programming interfaces (e.g. at the kernel level) for low power and embedded systems, including smartphones, digital media players, games consoles and set-top boxes.

These modes of integration may be set by a client device or application and the mechanism for selection and configuration will be described in more detail below.

The configuration of FIG. 2b, and the use of a decoder integration layer, allows LCEVC decoding and rendering to be integrated with many different types of existing legacy (i.e. base) decoder implementations. For example, the configuration of FIG. 2b may be seen as a retrofit for the configuration of FIG. 2a as may be found on computing devices. Further examples of integrations include the LCEVC decoding libraries being made available within common video coding tools such as FFmpeg and FFplay. For example, FFmpeg is often used as an underlying video coding tool within client applications. By configuring the decoder integration layer as a plug-in or patch for FFmpeg, an LCEVC-enabled FFmpeg decoder may be provided, such that client applications may use the known functionalities of FFmpeg and FFplay to decode LCEVC (i.e. enhanced) video streams. For example an LCEVC-enabled FFmpeg decoder may provide video decoding operations, such as: playback, decoding to YUV and running metrics (e.g. peak signal-to-noise ratio-PSNR or Video Multimethod Assessment Fusion-VMAF-metrics) without having to first decode to YUV. This may be possible by the plug-in or patch computer program code for FFmpeg calling functions provided by the decoder integration layer.

Through configuration settings, the decoder integration layer may be configured to work with different types of internal pipeline. For example, particular internal pipelines may control how stages of the decoding operation to be performed. In one case, different types of internal pipeline may distribute computation over one or more Central Processing Units (CPUs) and/or Graphical Processing Units (GPUs). In one case, two types of internal pipeline may be provided. A first example type may relate to a CPU-led operation, where the LCEVC stages (e.g. all the stages) are performed in CPU of a computing device running the LCEVC decoder. A CPU-led mode may only use Single instruction, Multiple Data (SIMD) acceleration, e.g. based on the implementation of the decoder plug-in(s) only. For this first example type, a GPU may be used only for possible YUV/RGB conversion. The first example type may not use the GPU functions 27c of FIG. 2b. A second example type may relate to a GPU-led operation, where the LCEVC stages (e.g. most or a predefined set) are performed by one or more GPU of the device running the LCEVC decoder. The second example type may use GPU functions such as 27c in FIG. 2b. For example, this second example type may use GL shaders, including YUV/RGB conversions, while the CPU is only used to produce the LCEVC residual planes at various levels of enhancement.

Myriad configurations may be set by the configuration data that is passed or set upon creation of an instance of the decoder integration layer. Further non-limiting examples which the client can configure in the decoder integration layer include: which of OpenGL major and minor versions should be used (or the decoder integration layer can be configured for auto configuration at the highest supported version); use of OpenGL ES; use of 8 bit LCEVC residual planes, for example instead of 16 bit; use of Hardware Buffers, for example in Android (RTM); enable an on-screen UI for statistics and live configuration; enable dumping statistics to local storage; and, enable dumping raw output frames to local storage.

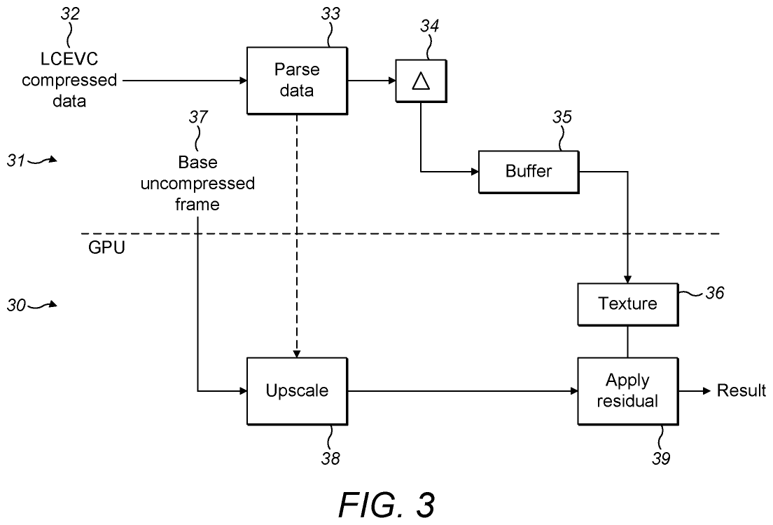

FIG. 3 illustrates an example of GPU-based implementation of LCEVC rendering. In the schematic view, to illustrate the principles of the invention, the diagram is divided in operations performed on GPU memory 30 and operations performed in general purpose of CPU memory 31. At a high-level it can be instantly seen that one of the challenges of using a GPU to render LVEVC video data is the transfer, or loading, of data from CPU to GPU. That is, the movement of data from one to the other is a resource intensive and inefficient process. In other words, sending data over the GPU boundary is a limiting constraint.

As indicated in the above-described figures, LCEVC streams are split into enhancement data and base data. In the illustration of FIG. 3, schematically it is shown that the process receives as inputs LCEVC compressed data 32 and a base uncompressed frame 37. With cross-reference to FIG. 1 we can see that the LCEVC decoder 10 receives the base uncompressed data from the base decoder 11 and the LCEVC compressed data from the demultiplexer 12.

The LCEVC compressed data 32 is parsed at block 33 to decode the LCEVC residuals data. The parsing function 33 may also control operation of the upscaler 38. In the implementation exemplified above, this may be performed by the decoder plug-ins (DPI) under control of the decoder integration layer (DIL). As set out in the LCEVC draft standard, the LCEVC residuals data is generated in the form of a temporal buffer and a set of preliminary residuals to be applied to the buffer. That is, the residuals from the previous frame are stored in the temporal buffer and the difference between the elements in the buffer and the elements of the frame are received in the stream (i.e. entropy coded, transformed and quantised form).

To implement the decoder, the temporal buffer stores the residuals of the previous frame and the residuals decoded from the stream are applied to the temporal buffer to create the frame of residuals that are applied to the base decoded frame to generate the surface.

More information on temporal signalling in LCEVC can be found in the Draft LCEVC standard specification, Draft Text of ISO/IEC DIS 23094-2 Low Complexity Enhancement Video Coding published at MPEG 129 meeting in Brussels, and WO2020/089618, which are both incorporated herein by reference in their entirety.

Conceptually, this process is illustrated in FIG. 3 as the LCEVC compressed data 23 is parsed 33 to derive the set of temporal, preliminary residuals 34 (indicated here with the symbol Δ) which are then combined with the temporal buffer 35 to create the frame of residuals data for rendering.

To implement the LCEVC rendering at the GPU, the base uncompressed frame 37 can be upscaled 38 to generate the upscaled, uncompressed frame of video data. This frame should be combined with the frame of LCEVC residuals data to create the Surface and the reconstructed frame of video.

After the temporal, preliminary residuals (Δ) 34 are combined with the temporal buffer 35, this may be loaded on to a texture at the GPU 36 and the GPU instructed to apply 39 this texture 36 to the upscaled, uncompressed frame. In this way the GPU is leveraged to combine the residual data and the image so as to render the Surface and the reconstructed video.

Such an approach however may not be optimal. This approach requires, for each frame, all values for the frame to be loaded across the GPU boundary, that is, the values stored in the temporal buffer 35 are each loaded into a texture buffer for the rendering of each frame. In other words, the process involves uploading pixels to a texture. This is resource intensive and applying the data to the GPU becomes a bottleneck.

The limitations of moving data to the GPU are not unique to LCEVC and such limitations occur with all generic CPUs—it is one of the reasons that GPUs on PCs use fast data transfer cards. Whenever it is an aim to transfer large amounts of data to a GPU then there is a limitation, that is, texture or buffer upload is limited or compromised by the bandwidth available.

It is thus an aim to reduce data transfer to the GPU when utilising a GPU to render a reconstructed video according to LCEVC. When applying sparse data to an image, i.e. applying LCEVC residuals to a decoded base frame, it is important to try to reduce the amount of data being transferred to the GPU so as to improve rendering efficiency.

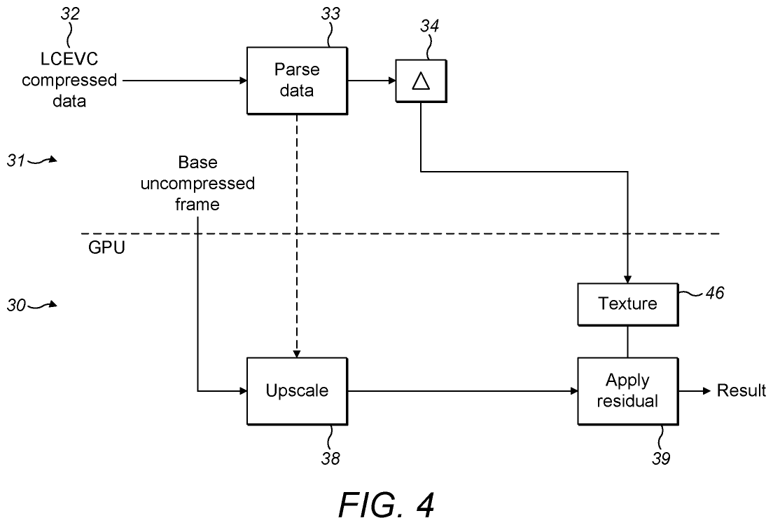

To address this aim, as conceptually illustrated in FIG. 4, the temporal buffer may be stored as a texture 46 on the GPU. In this example, the differences between the current frame of residuals and the temporal buffer, i.e. the temporal, preliminary residuals (Δ) 34 identified after parsing the enhancement data 33, may preferably be encoded as geometry data. This facilitates the temporal buffer being kept on the GPU.

Examples of the present disclosure may be implemented using different APIs for instructing the GPU, for example OpenGL, OpenGL ES, Metal, Vulkan and other graphics APIs suitable for instructing the GPU to perform operations. The use of a particular API is not limited with the present disclosure. In examples, OpenGL shaders may be used written in OpenGL Shading Language (GLSL).

Referring once again to FIG. 4 we can see that compared to FIG. 3, the temporal buffer 35 has been moved to the GPU where it is stored as a texture 46. The GPU is then instructed to apply 39 that texture to the upscaled, base uncompressed image 38 to generate the Surface, i.e. the result used to reconstruct the video.

Storage of the buffer is not the same as data upload. It is important to consider how to transfer the temporal differences quickly and efficiently and whether or not a data conversion process is beneficial.

Residuals data in LCEVC is typically coded in one of two formats. As stated in the LCEVC standard, a residuals plane is divided into coding units whose size depends on the size of the transform used. The coding units have either dimension 2×2 if a 2×2 directional decomposition transform is used (DD) or a dimension 4×4 if a 4×4 directional decomposition is used (DDS). The specifics of the decompositions are not important but further details may be found the Draft LCEVC standard specification, Draft Text of ISO/IEC DIS 23094-2 Low Complexity Enhancement Video Coding published at MPEG 129 meeting in Brussels, WO2020/089618 and in WO2020/025957, each of which are both incorporated herein by reference in their entirety.

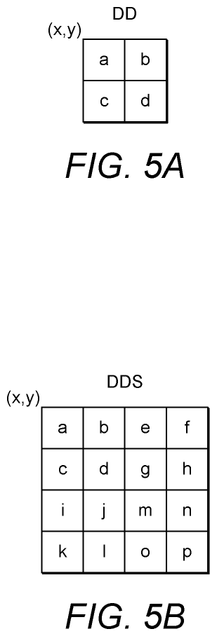

According to one example illustrated conceptually in FIGS. 5A and B, as mentioned above the differences may be sent to the GPU as geometry data. The geometry data can then be consumed by GPU shaders, for example, by a vertex shader and a fragment shader in order to map the texture.

In one example the GPU may be instructed to draw a set of points to the texture, i.e. the difference values individually, for example as blocks 4 at a time.

In a further example, the data for each block may be sent as a set of vertices and attributes which can be drawn by the GPU to update the texture when the texture is acting as the frame or temporal buffer.

As illustrated in FIG. 5A, the data may be encoded as one value representing the location of the block in the frame (x,y) and a set of four values of the block (a,b,c,d). That is, to load the data for a specific DD coding unit there may be required 4 coefficients and a 2-dimensional coordinate to locate that block in the frame, i.e. 6 values.

As illustrated in FIG. 5B, for a 4×4 coding unit, the data may be sent as four sets of locations and values, as described above. This may additionally require sending locations of the other blocks, such as (x+2,y) and appropriate values (e, f, g, h). That is, to load the data for a specific 4×4 coding unit (referred to as a DDS coding unit), there may be required 16 coefficients and 4 2-dimensional coordinates to locate the parts of that block in the frame, i.e. 24 values.

In a further example as illustrated in FIG. 5B, for a 4×4 coding unit, the data may be sent as a location of the block (x,y) and a set of 16 values (a,b,c,d,e,f,g,h,i,j,k,l,m,n,o,p). That is, to load the data for a specific DDS coding unit, there may be required 16 coefficients and a 2-dimensional coordinate to locate that block in the frame, i.e. 18 values.

The coordinate of each block may be any location to enable the block to be located. Here in this preferred example, the block is located by the coordinates of the top left of the block of the frame, (x,y)

There may be numerous ways to instruct the GPU to draw the data and to send the information the GPU.

In one example, the 2×2 block may be sent as one vertex encoding the location of the block (i.e. the top-left coordinate in this example) as one attribute and one attribute encoding the values of the block. For example, the first attribute may indicate the position and the second attribute may indicate the value. Here in these examples we refer to “Colour”. This will be become clear in the detailed example below in which we describe texture packing. What is clear though for now is that the attributes of a vertex may include the 6 values needed to load the DD coding unit onto the GPU.

| | Attribute | |
|---|---|---|
| Vertex | 0 | Position (x, y) |
| | 1 | “Colour” (a, b, c, d) |

In another example, the 4×4 block of data may be sent as one vertex and five attributes, in a similar manner to the table above; alternatively as four vertices with two attributes each, as indicated in the table below. There thus exists multiple ways to code the data efficiently in order to load the data to the GPU.

| | Attribute | |
|---|---|---|
| Vertex | 0 | Position (x, y) |
| | 1 | “Colour” (a, b, c, d) |
| Vertex | 0 | Position (x + 2, y) |
| | 1 | “Colour” (e, f, g, h) |
| Vertex | 0 | Position (x, y + 2) |
| | 1 | “Colour” (i, j, k, l) |
| Vertex | 0 | Position (x + 2, y + 2) |
| | 1 | “Colour” (m, n, o, p) |

In preferred implementations the steps of instructing the GPU may be implemented at the decoder integration layer. In optional implementations, the DPI is modified so that instead of providing the residuals an image plane, the DPI provides a list of operations needed to change the last frame's residual image to this current residual image. The operations may be embedded in the stream, for example as transform or coding units.

As described at a high-level above, the DPI aims to modify the temporal buffer to include the changes in the current frame. According to examples of the present disclosure the decoder integration layer (DIL) is configured to received instructions from the DPI and instruct the GPU to draw onto a texture to implement the instructed changes, such that the GPU texture acts as the temporal buffer.

Examples of configured operations include SET, CLEAR and APPLY. A SET operation instructs the DIL to set or change the values of a block to specific values.

A CLEAR operation instructs the DIL to clear or delete the values of a 32×32 tile containing multiple blocks and an APPLY operation instructs the DIL to combine the values of a block with the values already in the buffer at that location.

As above, each of the operations may be drawn differently through instruction by the DIL to the GPU. In an example implementation, the SET and APPLY operations may be instructed by the DIL to the GPU as a draw command of points, drawing one or more vertices or attributes as set out in the examples above. In an optional implementation, a CLEAR operation may be instructed to the GPU as a draw command of one or more triangles, for example, a tristrip of two triangles with a location of (x,y) implemented as six vertices with one attribute each (i.e. to draw two triangles of size 32 to clear a 32×32 block, vertices may be: (x,y), (x +32,y), (x+32,y+32), (x,y), (x+32,y+32), (x,y+32)). These two triangles can be used to clear a block of a set size in the texture acting as the temporal buffer.

A further operation may wipe all data stored in the buffer, i.e. may clear all data in the texture.

In preferred implementations, the DIL may group all instructions together and send all operations of a particular type to the GPU as a single draw command. For example, the DIL may send all CLEAR instructions, all SET instructions and all APPLY instructions as a single respective draw operation to the GPU for each type of operation to update the texture (the texture acting as the temporal buffer). Let's assume for example that all the DPI instructs the DIL to SET five blocks of residuals in the frame of preliminary residuals and to CLEAR 4 other blocks. The DIL may send all SET operations with one draw command to draw all the appropriate points and all CLEAR operations with one CLEAR draw command to draw the necessary triangles to clear the indicated blocks.

As will be clearly understood the GPU then receives those operations and makes the necessary changes to the texture such that the texture then acts as the temporal buffer. The temporal buffer can then be combined, after the preliminary residuals have been applied, to the frame of base uncompressed data to generate the Surface for reconstructing the frame of video.

In order to send the data to the GPU in an efficient manner and save memory, the data may be stored in an upload packing or texture packing manner. In this manner, since the residuals values are a 2-dimensional array, the implementation may pretend there are four components when there are not. For example, each value of the block to be applied to the texture may be sent to the GPU as a value of a component. Typically there may be four components, Red, Green, Blue and Alpha. Different geometries of packing the data to the GPU for efficiency are contemplated.

In the case where the number of values being sent to the GPU per location is greater than the number of components (typically four) in the texture used for the temporal buffer, it may be necessary to have a way of accessing texels other than the one at the location specified. In the case of OpenGI a geometry shader may be used.

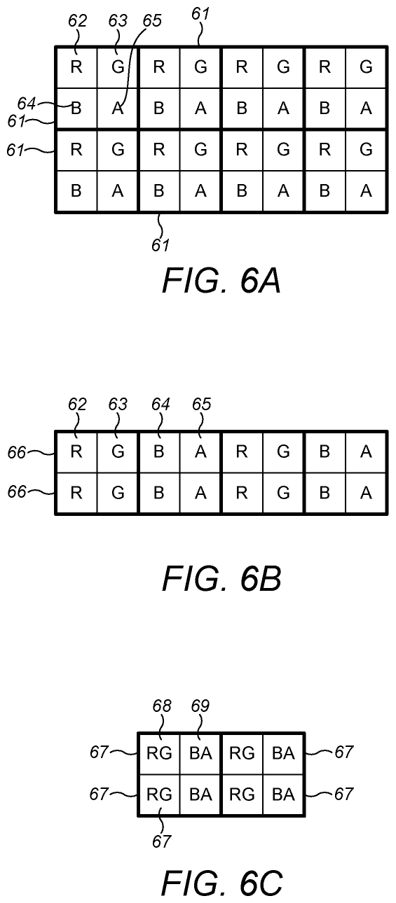

FIGS. 6A to C illustrate these texture packing examples conceptually. FIG. 6A illustrates how the four values of each block 61 can be packed as four component values, each corresponding to one component, i.e. R 62, G 63, B, 64, A, 65. This may also be referred to as channel packing.

The example of FIG. 6A may apply to both DD and DDS coding units, in which each value of a 2×2 block (i.e. a sub-unit of the 4×4 coding unit) may be mapped to a respective channel of a pixel of the texture. FIG. 6B describes a further texture packing example for a 4×4 coding unit, i.e. a DDS coding unit. The values of the coding unit may be stored as 4×1 elements, with each row of the 4×4 block each corresponding to one set of component values for a pixel of the texture.

FIG. 6C illustrates an example of packing 16-bit values into 8-bit textures. As can be seen the value of each element may be split across two components of the texture. For example, the most significant bit of the residual element may be stored in the R channel and the least significant bit stored in the G component.

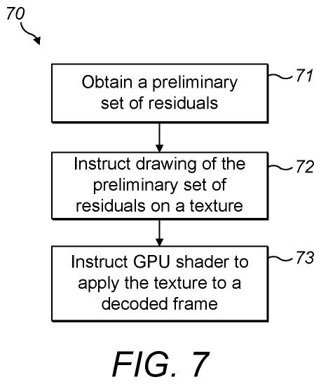

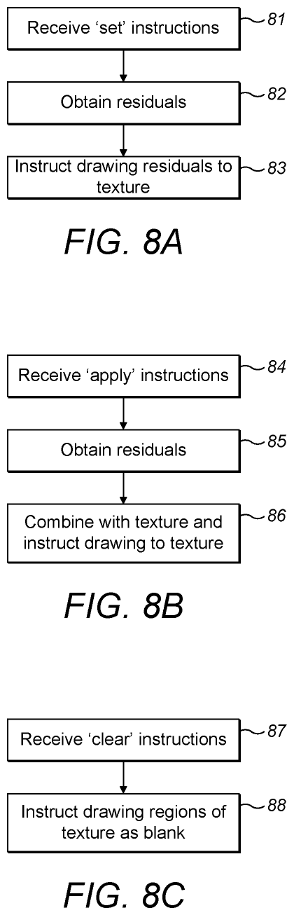

For completeness, FIGS. 7 and 8A to C illustrate example steps taken by a module to instruct a GPU to operate a texture as a temporal buffer according to a enhancement decoding technology. In the preferred examples given here, the enhancement decoding technology is LCEVC and the module performing the instruction is a decoder integration layer which communicates with a client or application and one or more decoder plug-ins. It will be of course be understood that the DIL and DPI are optional implementations only and any module suitable of performing the steps may be used, depending on the integration implementation of the enhancement decoding technology.

In the example flow diagram 70 of FIG. 7, first, the module obtains a preliminary set of residuals (step 71). The preliminary set of residuals may be a difference between the state of a temporal buffer and the current frame of residuals as sent in the enhancement stream. The module may then instruct combining the preliminary set of residuals on a texture at a GPU (step 72). It is to be understood that instructing combining may involve instructing drawing or instructing directly addressing elements of the texture to modify elements of the texture. Specifically, the module may instruct the drawing of the preliminary set of residuals on a texture at a GPU. Examples of how this command may be drawn have been discussed at length above, including texture packing and the encoding of the preliminary set of residuals as geometry data. In short however, the module instructs the GPU to draw the preliminary set of residuals on a texture so that the texture acts as a temporal buffer.

As will be discussed below, instructing combining the preliminary residuals with the texture may involve invoking a compute shader to directly address elements of the texture.

Optionally, the module then instructs a GPU shader to apply the texture, acting as a temporal buffer, to a decoded frame (step 73). The decoded frame being a base uncompressed frame, optionally being upscaled, so as to reconstruct a Surface from a combination of the residuals data (i.e. the temporal buffer combined with the preliminary set of residuals) and the base uncompressed frame.

In an example implementation pipeline, e.g. using OpenGL, the stages of the pipeline may be as follows:
The input to the pipeline may be an RGB base texture which is colour converted into separate Luma and Chroma planes (Y, U and V). Each plane is stored in an OpenGL texture.
Each of these textures are passed to a separate DIL OpenGL Core Pipeline.
Once the pipelines are complete, the outputs are merged to produce a final output RGB texture (RGBA if required).
This output texture can be rendered by a player application.

In an example implementation pipeline, e.g. an OpenGL Core Pipeline, the stages may be as follows (e.g. for Y plane only):
The input may be a texture of base resolution.
I Layer 1 processing stage 1.
   Upscale (Horizontal).
Layer 1 processing stage 2.
   Upscale (Vertical).
   Apply Residuals—(Optional) Combine texture from previous step with residual texture.
Layer 2 processing stage 1.
   Upscale (Horizontal)-(Optional) Horizontal upscale.
Layer 2 processing stage 2.
   Upscale (Vertical)—(Optional) Vertical upscale.
   Apply Residuals—(Optional) Combine texture from previous step with residual texture.
The output is a single texture of the output size.

For U and V planes, the DIL OpenGL Core Pipeline may in certain examples be a simple upscale.

FIGS. 8A to C illustrate flow diagrams for the module in a further example in which the module implements specific instructions received to perform modifications to a temporal buffer of an enhancement coding technology. In the examples herein the module is a decoder integration layer and the instructions are received from a decoder plug-in, however, the instructions may similarly be derived from parsing the enhancement stream to identify the instructions without utilising decoder plug-ins, that is a module may perform the functionality of parsing the enhancement stream and identifying the modifications needed to the temporal buffer for that temporal buffer to be applied to the base uncompressed frame to create the Surface corresponding to the input frame.

FIG. 8A illustrates the module may first receive one or more ‘set’ instructions which indicate that the temporal buffer should set the values of a region of the temporal buffer to a particular value (step 81). The module, based on this instruction, obtains the preliminary set of residuals to be set to the buffer (step 82) and instructs the GPU to draw the values to the texture (step 83), such that the texture acts as the temporal buffer.

FIG. 8B illustrates the module may receive one or more ‘apply’ instructions which indicate that the temporal buffer should combine the existing values of a region of the buffer with a particular value (step 84). The module, based on this instruction, obtains the preliminary set of residuals to be applied to the buffer (step 85) and instructs the GPU to combine those values with the values already set in the buffer and draw those values to the texture (step 86), such that the texture acts as the temporal buffer.

FIG. 8C illustrates the module may receive one or more ‘clear’ instructions which indicate that a region of the temporal buffer should be cleared (step 87). Typically a CLEAR instruction will be the first operation performed within a frame. The module, based on this instruction, sends a draw command to the GPU to draw a region of the texture as blank (step 88), such that the texture acts as the temporal buffer. As set out in the examples above, this may be performed through drawing blank points on the texture or through the drawing of a geometric shape on the texture having a predetermined value, or no value.

As can be understood from the above, there are practical limitations to the implementation of enhancement coding using a GPU to render and reconstruct the original input video because of the limitations of the bandwidth of the communication between GPU and CPU. The present disclosure presents solutions to this problem by utilising a texture of the GPU as the temporal buffer of the enhancement coding technology and drawing received preliminary sets of residuals onto that texture so that the texture can be subsequently applied to a base uncompressed frame of data. Uploading pixels to a texture is not generally efficient. However, leveraging the sparse data and lines of the enhancement residuals it becomes advantageous to draw the data using the GPU. As such, aspects of the present disclosure present efficient mechanisms of controlling operation of enhancement reconstruction and rendering using a GPU.

In addition to using a fragment shader to draw vertices on a texture, as described above, it is also contemplated that a compute shader of a GPU may be invoked to directly address pixels corresponding to transform units. The transform units, or coding units may be 2×2 or 4×4 blocks, as described above and set out in the exemplary LCEVC specification . . .

As mentioned above, where combining of the preliminary residuals is instructed, this could mean that the preliminary residuals are directly addressed.

Typically, when invoking a fragment shader on a pixel corresponding to a transform unit, the fragment shader of a GPU is invoked on the entire 2×2 pixel group regardless of the number of pixels in the 2×2 group that actually contain data. This results in a number of wasted invocations.

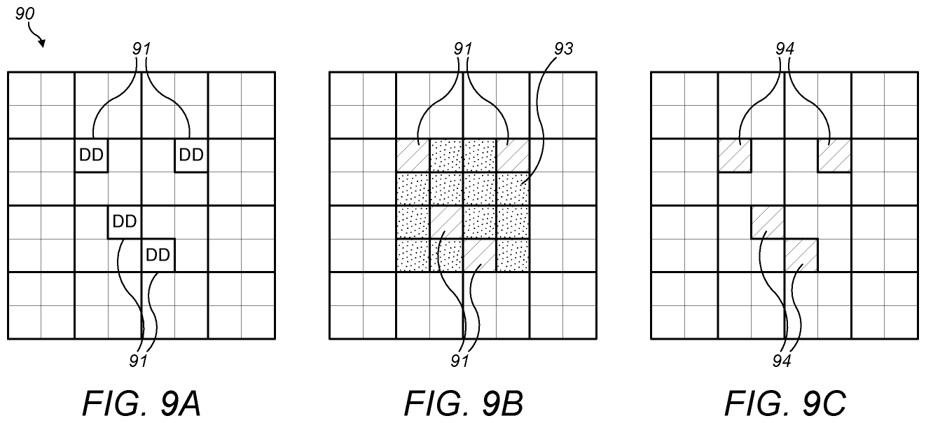

For example, referring to FIG. 9A, a grid of pixels 90 is shown. The grid is segmented into 2×2 quadrants. The grid shown in FIG. 9 may be an array of residual data, i.e. the temporal buffer acting as a texture discussed above.

FIG. 9A also shows four pixels which correspond to 4 respective coding units 91. In the terminology of LCEVC, these are DD transform units. Typically, GPUs are configured so that when a fragment shader is to be invoked on one of the pixels corresponding to a DD transform unit, the fragment shader is also invoked on (or for) all other pixels in a 2×2 block that contains the pixel corresponding to the transform unit.

This is shown in FIG. 9B. It can be seen in FIG. 9B for the four DD transform units 92 that are consumed by the fragment shader, a total of 16 fragment shader invocations are needed. Of these, 12 fragment shader invocations are executed but then wasted, shown as dotted pixels 93 in FIG. 9B, and only 4 are used, shown by the hatched pixels 92 in FIG. 9B. The use of fragment shaders in this scenario may be computationally wasteful, as 75% of the fragment shader invocations are discarded.

Instead, according to the present example, a compute shader is used to directly address the pixels with the corresponding transform units. This is shown in FIG. 9C. As can be seen in FIG. 9C, only the pixels corresponding to the transform units 94 are addressed by the compute shader. As such, no compute shader invocations are wasted, providing direct efficiency improvements.

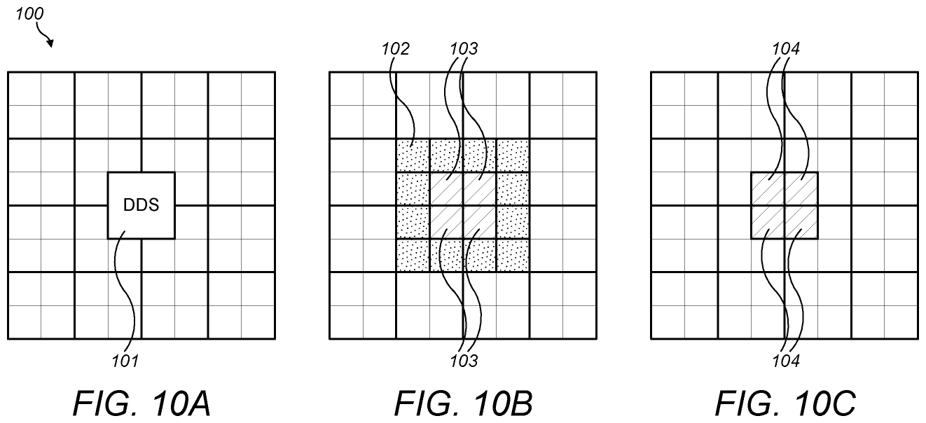

The above concept of using a compute shader instead of a fragment shader is particularly useful for DD transform units. However, as shown in FIGS. 10A to 10C, the concept may also be applied to DDS transform units (using the terminology of LCEVC), i.e. 4×4 coding units, which may be misaligned with the 2×2 quadrants of the pixel grid 100.

FIG. 10A shows a DDS transform unit 101 on a pixel grid 101.

As shown in FIG. 10B, in the event that the DDS transform block is misaligned with the 2×2 quadrants of the grid, this can lead to wastage of fragment shader invocations. Again, FIG. 10B shows that 16 fragment shader invocations are executed, of which 12 are executed on inactive pixels, shown by the dotted pixels 102, and only 4 are executed on the DDS transform unit, shown by the hatched pixels 103. As explained above, by using invoking a compute shader only the pixels corresponding to the DDS transform unit, no shader invocations are wasted.

This is shown in FIG. 10C. The compute shader is invoked only for pixels 104 corresponding to the DDS transform unit.

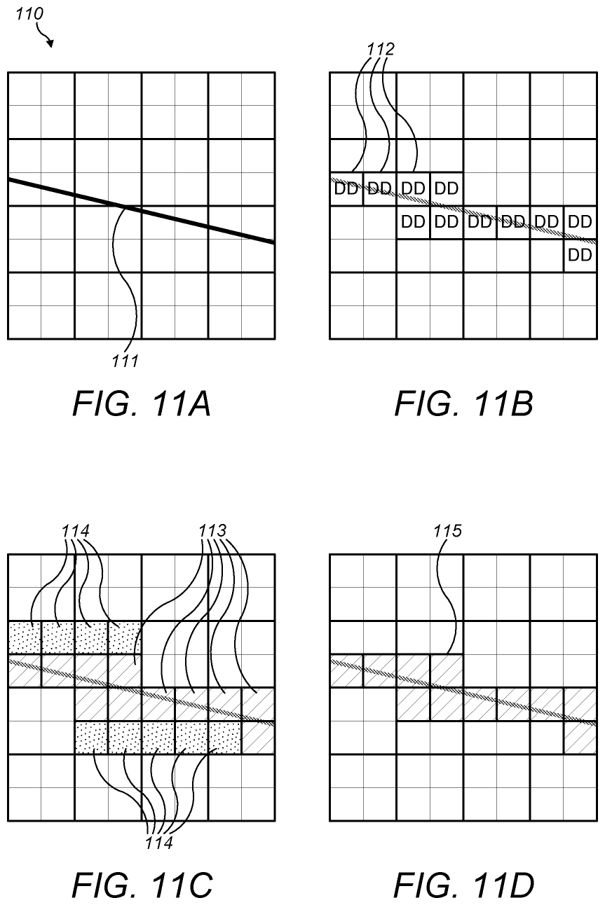

A practical example is given by FIGS. 11A to 11D. FIG. 11A shows a diagonal line 111 traversing a pixel grid 110. FIG. 11B shows the DD transform units 112 corresponding to the diagonal line 111 shown in FIG. 11A. FIG. 11C shows how a fragment shader may be invoked on the DD transform units 113, and how this results in 9 out of 20 fragment shader invocations being wasted. The wasted fragment shader invocations are shown by the dotted pixels 114, and the useful fragment shader invocations are shown by the hatched pixels 113. Finally, FIG. 11D shows that by directly addressing each of the DD coding units 115 with a compute shader, no shader jobs are wasted.

Using a compute shader effectively bypasses a number of steps in the OpenGL standard rendering pipeline. Some processes relevant to a fragment shader in the OpenGL pipeline are wasteful, so using a compute shader instead of a fragment shader provides further efficiency improvements by excluding those processes. For example, the processes of rasterization, blending, depth testing, scissor testing, stencil testing may be excluded. In addition, vertex operation relevant to a vertex shader are also done away with, for example primitive assembly.

Further, a compute shader can be invoked directly on a texture and can retrieve, or be passed, data from any suitable location. This is relevant as the data output from a codec, for example preliminary residual data, does not need to be rearranged by a CPU before it can be consumed by the compute shader. This provides a bandwidth saving since there is no need to send data relating to the location of the transform unit to the GPU.

A further advantage leverages the configuration of modern GPUs. That is, modern GPUs typically include two queues, namely a graphics queue and a compute queue. Tasks on the different queues may be performed in parallel. Fragment shader jobs are placed on the graphics queue, and compute shader jobs are added to the compute queue. By taking some of the fragment shader jobs off of the graphics queue and instead making use of the compute queue, further performance improvements are gained, since the tasks on the compute queue and the tasks on the graphics queue may be performed in parallel. Therefore the use of compute shaders allows the GPU to leverage parallel processing of shader jobs.

Fragment shaders may be preferred due to their prevalence in old and new devices. However, the use of compute shaders instead of fragment shaders in certain applications may provide efficiency and performance advantages as discussed above.

Embodiments of the disclosure may be performed at a decoder or in a module of a decoder, for example implemented in a client device or client device decoding from a data store. Methods and processes described herein can be embodied as code (e.g., software code) and/or data.

The decoder may be implemented in hardware or software as is well-known in the art of data compression. For example, hardware acceleration using a specifically programmed Graphical Processing Unit (GPU) or a specifically designed Field Programmable Gate Array (FPGA) may provide certain efficiencies. For completeness, such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system).

Generally, any of the functionality described in this text or illustrated in the figures can be implemented using software, firmware (e.g., fixed logic circuitry), programmable or nonprogrammable hardware, or a combination of these implementations. The terms “component” or “function” as used herein generally represents software, firmware, hardware or a combination of these. For instance, in the case of a software implementation, the terms “component” or “function” may refer to program code that performs specified tasks when executed on a processing device or devices. The illustrated separation of components and functions into distinct units may reflect any actual or conceptual physical grouping and allocation of such software and/or hardware and tasks.

1. A method of implementing an enhancement decoding, comprising:
obtaining a preliminary set of residuals from an encoded enhancement signal comprising one or more layers of residual data, the one or more layers of residual data being generated based on a comparison of data derived from a decoded video signal and data derived from an original input video signal; and,
instructing combining the preliminary set of residuals with a texture of a GPU to combine the preliminary set of residuals with a set of temporal residual values, wherein the texture acts as a temporal buffer storing the set of temporal residual values.

2. A method according to claim 1, further comprising:
instructing a GPU shader to apply the texture to a decoded frame of video to generate a decoded reconstruction of the original input signal.

3. A method according to any preceding claim, wherein the step of instructing combining comprises:
instructing the GPU using an api of the GPU and storing the preliminary set of residuals in memory accessible by the GPU.

4. A method according to any of claims 2 to 3 wherein the instructing combining comprises:
packing values of the preliminary set of residuals as channel values of the texture.

5. A method according to claim 4 wherein each value of a 2 by 2 block of a frame of the preliminary set of residuals is packed into respective channels of the texture.

6. A method according to claim 5 wherein each 4 by 1 row or column of a 4 by 4 block of a frame of the preliminary set of residuals is packed into the channels of a pixel of the texture.

7. A method according to any of claims 2 to 6 further comprising encoding the preliminary set of residuals as geometry data.

8. A method according to any preceding claim, wherein instructing combining comprises instructing a drawing of the preliminary set of residuals on the texture of the GPU.

9. A method according to any of claims 1 to 7, wherein instructing combining comprises instructing addressing elements of the texture to modify the texture data.

10. A method according to claim 9, wherein the instructing combining comprises instructing directly addressing elements of the texture to modify the texture data.

11. A method according to any of claims 9 to 10, wherein the instructing comprises invoking a compute shader to directly address the elements of the texture.

12. A method according to claim 11, wherein each element of the texture is directly addressed by the compute shader.

13. A method according to claim 7 or 8, wherein the preliminary set of residuals are encoded as at least one vertex and at least one attribute.

14. A method according to claim 13, wherein the at least one attribute comprises an attribute corresponding to a location of residuals in a frame and at least one attribute corresponding to a value of a residual in the preliminary set of residuals.

15. A method according to claim 14, wherein a 2 by 2 block of a frame of the preliminary set of residuals is encoded as one vertex and two attributes, wherein a first attribute comprises a location of the block in the frame and a second attribute comprises values of each residual in the block.

16. A method according to claim 15, wherein the second attribute comprises four channel values, each channel value including a respective residual value in the block.

17. A method according to claim 13, wherein a 4 by 4 block of a frame of the preliminary set of residuals is encoded as one vertex and five attributes, wherein a first attribute comprises a location of the block in the frame and four attributes comprise values of each residual in the block.

18. A method according to any preceding claim, further comprising:
obtaining an instruction to set or apply a plurality of residual values in the preliminary set of residuals to a region of the temporal buffer; and,
drawing the plurality of residual values on the texture as a plurality of points.

19. A method according to any preceding claim, further comprising:
obtaining an instruction to clear a region of the temporal buffer;
encoding the instruction as at least one triangle; and,
drawing the at least one triangle on the texture to clear a region of the texture.

20. A method according to claim 19, further comprising:
encoding the instruction as six vertices and one attribute.

21. A method according to any preceding claim, further comprising:
obtaining a plurality of instructions to perform operations on the temporal buffer for a frame of the preliminary set of residuals, each of the plurality of instructions having an associated operation type;
grouping the plurality of instructions together according to their associated operation type; and,
sending each group of instructions to the GPU as a single drawing operation.

22. A method according to any preceding claim, wherein the method is performed at a decoder integration layer which controls operation of one or more decoder plug-ins and an enhancement decoder to generate a decoded reconstruction of the original input video signal using a decoded video signal from a base encoding layer and one or more layers of residual data from the enhancement encoding layer, wherein the one or more decoder plug-ins provide a wrapper for one or more respective base decoders to implement a base decoding layer to decode an encoded video signal, each wrapper implementing an interface for data exchange with a corresponding base decoder and wherein the enhancement decoder implements the enhancement decoding layer, the enhancement decoder being configured to:
receive an encoded enhancement signal; and,
decode the encoded enhancement signal to obtain the one or more layers of residual data.

23. A method according to claim 22, further comprising:
receiving one or more instructions from the one or more decoder plug-ins, the instructions instructing an update of the temporal buffer; and,
converting the one or more instructions into one or more draw operations to be sent to the GPU to update the texture.

24. A computer readable medium comprising instructions which when executed by a processor, cause the processor to perform the method according to any preceding claim.

25. A video decoder, comprising:
a decoder integration layer to generate a decoded reconstruction of the original input video signal using a decoded video signal from a base encoding layer and one or more layers of residual data from an enhancement encoding layer, wherein the decoder integration layer is configured to perform the method of any of claims 1 to 21.

26. A video decoder, according to claim 25, further comprising:
one or more decoder plug-ins that provide a wrapper for one or more respective base decoders to implement a base decoding layer to decode an encoded video signal, each wrapper implementing an interface for data exchange with a corresponding base decoder;
an enhancement decoder to implement an enhancement decoding layer, the enhancement decoder being configured to:
receive an encoded enhancement signal; and,
decode the encoded enhancement signal to obtain one or more layers of residual data, the one or more layers of residual data being generated based on a comparison of data derived from the decoded video signal and data derived from an original input video signal, and wherein the decoder integration layer provides a control interface for the video decoder.

27. A video decoding system, comprising:
a video decoder according to claim 25 or 26; and,
one or more base decoders.

28. A video decoding system according to claim 27, further comprising a client which provides one or more calls to the video decoder via the control interface to instruct generation of a decoded reconstruction of an original input video signal using the video decoder.
